(19) United States
(12) Patent Application Publication
(10) Pub. No.: US 2021/0149082 A1
(43) Pub. Date: May 20, 2021

(54) PLANAR ACHROMATIC AND DISPERSION-TAILORED META-SURFACES IN VISIBLE SPECTRUM

(71) Applicant: PRESIDENT AND FELLOWS OF HARVARD COLLEGE, Cambridge, MA (US)

(72) Inventors: Wei Ting CHEN, Cambridge, MA (US); Vyshakh SANJEEV, Cambridge, MA (US); Alexander Yutong ZHU, Cambridge, MA (US); Mohammadreza KHORASANINEJAD, Cambridge, MA (US); Zhujun SHI, Cambridge, MA (US); Federico CAPASSO, Cambridge, MA (US)

(73) Assignee: PRESIDENT AND FELLOWS OF HARVARD COLLEGE, Cambridge, MA (US)

(21) Appl. No.: 16/616,915

(22) PCT Filed: May 31, 2018
(86) PCT No.: PCT/US2018/035502

§ 371 Date: Nov. 25, 2019

Related U.S. Application Data
(60) Provisional application No. 62/514,614, filed on Jun. 2, 2017.

(51) Int. Cl. G02B 1/00; G02B 5/18; G02B 6/34

(52) U.S. Cl. CPC G02B 1/002; G02B 5/1871; G02B 27/0025; G02B 6/34; G02B 2207/101; G02B 5/1809

(57) ABSTRACT

An optical device comprises a metasurface including a plurality of nanostructures. The nanostructures define a phase profile and a group delay profile at a design wavelength. The phase profile and the group delay profile determine and control the functionalities and the chromatic dispersion of the metasurface.

### CROSS-REFERENCE TO RELATED APPLICATIONS

This application claims the benefit of and priority to U.S. Provisional Patent Application 62/514,614, filed Jun. 2, 2017, which is incorporated herein by reference in its entirety.

### STATEMENT OF FEDERALLY SPONSORED RESEARCH OR DEVELOPMENT

This invention is made with Government support under FA9550-14-1-0389 and FA9550-16-1-0156, awarded by Air Force Office of Scientific Research. The Government has certain rights in the invention.

### BACKGROUND

Conventional refractive optical components such as prisms and lenses are manufactured by glass polishing. The drawbacks include bulky sizes, high manufacturing costs and limited manufacturing precisions, which prevent the optical components from being used in various applications, particularly portable systems and conformal or wearable devices. Using diffractive or metasurface elements are used for realizing compact, high-performance and scalable optical components. However, the performance of these diffractive or metasurface elements commonly suffers from chromatic aberrations: this is the undesired dispersion of light due to a failure to focus light of different colors along a desired light path or to a single convergence point. For example, chromatic aberrations may manifest as fringes of colors along boundaries separating dark and bright parts of an image.

### SUMMARY

According to at least some embodiments of the present disclosure, achromatic or dispersion-tailored devices in transmission configuration (e.g. an achromatic beam deflector and/or an achromatic lens) may be achieved by simultaneously controlling the phase and group delay. The devices may have a large continuous bandwidth in a visible spectrum. Compact and planar transmissive meta-lenses with tailored Abbe numbers, from negative to positive values, may be realized. For example, an achromatic meta-lens (with numerical aperture (NA) of, e.g., 0.2) over a 120 nm bandwidth centered at 530 nm may be achieved. These devices may be manufactured by two-photo polymerization and/or multi-lithography processes to overcome the drawbacks and challenges of lens-polishing techniques. Furthermore, by cascading another layer of achromatic meta-surface, an aberration-free meta-lens may be realized, which can find applications in, e.g., lithography, microscopy, spectroscopy and endoscopy.

As used herein, the term “visible spectrum” refers to wavelengths visible to humans. The term encompasses an entire range of wavelengths visible across the human population. It is to be understood, however, that this range will vary between specific humans. For example, the visible spectrum may encompass wavelengths from about 400 nm to about 700 nm. Additionally, the meta-lenses described herein may be optimized for certain subranges of the visible spectrum, or for certain ranges out of the visible spectrum (e.g., infrared (IR) or near-infrared (NIR) spectrums).

### BRIEF DESCRIPTION OF THE DRAWINGS

For a better understanding of the nature and objects of some embodiments of this disclosure, reference should be made to the following detailed description taken in conjunction with the accompanying drawings.

FIG. 1A shows schematics illustrating chromatic effect in refractive and diffractive optics, as well as an achromatic meta-surface beam deflector.

FIG. 1B shows schematics illustrating chromatic effect in refractive and diffractive optics, as well as an achromatic meta-surface beam deflector.

FIG. 1C shows schematics illustrating chromatic effect in refractive and diffractive optics, as well as an achromatic meta-surface beam deflector.

FIG. 2A illustrates simulations of optical properties of nanostructures.

FIG. 2B illustrates simulations of optical properties of nanostructures.

FIG. 2C illustrates simulations of optical properties of nanostructures.

FIG. 3A schematically illustrates a beam deflector with controlling group delay.

FIG. 3B schematically illustrates a beam deflector without controlling group delay.

FIG. 3C illustrates absolute beam deflection efficiencies and deflection angles as functions of wavelengths for the beam deflector of FIG. 3A.

FIG. 3D illustrates absolute beam deflection efficiencies and deflection angles as functions of wavelengths for the beam deflector of FIG. 3B.

FIG. 4A illustrates group delays as a function of radial lens coordinate.

FIG. 4B illustrates group delay dispersions as a function of radial lens coordinate.

FIG. 5A illustrates simulated point spread functions of meta-lenses with order n=0, where the focal length F=k·wⁿ (k and w are a constant and the angular frequency of light).

FIG. 5B illustrates simulated point spread functions of meta-lenses with order n=1, where the focal length F=k·wⁿ (k and w are a constant and the angular frequency of light).

FIG. 5C illustrates simulated point spread functions of meta-lenses with order n=2, where the focal length F=k·wⁿ (k and w are a constant and the angular frequency of light).

FIG. 6 illustrates normalized focal length shifts as functions of wavelengths for different meta-lenses from 450 nm to 700 nm, corresponding to the meta-lenses shown in FIGS. 5A-5C, together with a meta-lens that has a reversed focal length shift (order n=−1).

### DETAILED DESCRIPTION

Conventional imaging devices include multiple conventional lenses that are bulky and expensive. The bulky and expensive compound lenses limit the type of applications that can implement using such conventional imaging devices and hinders their integration into compact and cost-effective systems.

Metasurfaces have emerged as a way of controlling light through optical properties of sub-wavelength or wavelength scale structures patterned on a flat surface. The sub-wavelength or wavelength scale structures are designed for locally changing the amplitudes, polarizations and/or phases of incident light beams in order to realize various optical devices in a compact configuration. The metasurfaces provide a versatile platform for locally modulating the phase of an incident wavefront. The metasurfaces may be used in various compact optical elements, e.g., lenses, polarimeters, axicons, holograms, etc. However, even though the metasurfaces may include weakly dispersive materials (e.g., metals or dielectrics), the optical components using metasurfaces and/or diffractive optics may still be highly chromatic. In other words, the optical components may suffer from chromatic aberration.

At least some embodiments of the present disclosure describe an approach to address the chromatic aberration issue. Various achromatic or even dispersion-tailored optical devices in transmission may be realized by designing the phase profile and group delay independently. The devices may use a single layer (or multiple layers) of planar nanostructures with thicknesses at or around the wavelength scale. The achromatic optical devices may be, e.g., beam deflectors and lenses with diffraction-limited focusing capabilities within a large continuous bandwidth (e.g., more than about 120 nanometers (nm)). Unlike conventional devices that operate at multiple discrete wavelengths or a relatively narrow bandwidth, the disclosed optical devices can be realized as a wide variety of compact achromatic and dispersion-tailored elements.

According to at least some embodiments of the present disclosure, the group delay is tailored, while simultaneously and independently varying the phase mask from 0 to 2π. Thus, achromatic optical elements including metasurfaces in transmission configuration may be achieved in, e.g., a visible spectrum. In some embodiments, for example, an achromatic meta-lens with a numerical aperture NA=about 0.2 at about 530 nm can be achieved with a negligible focal length shift over a continuous bandwidth of about 120 nanometers. In addition, the dispersion can also be tailored, resulting in tunable equivalent Abbe numbers.

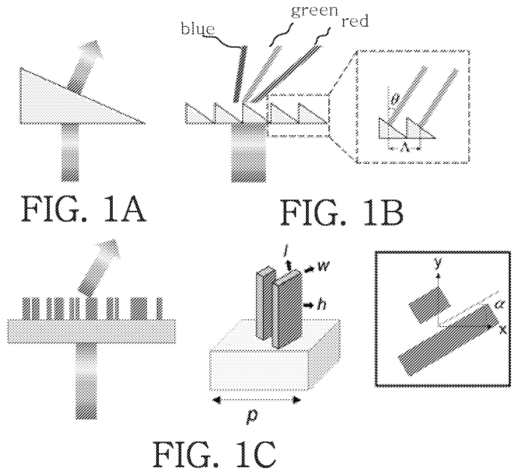

FIGS. 1A, 1B, 1C and 1D show schematics illustrating the chromatic effect in refractive and diffractive optics, as well as an achromatic meta-surface beam deflector. FIG. 1A shows a conventional glass prism. It is assumed that the glass prism has a constant refractive index. As shown in FIG. 1A, a broadband chromatic beam is deflected by the prism by an angle. FIG. 1B shows a diffractive counterpart of the prism of FIG. 1A, which may be an optical component including a group of stitched small prisms. As the prisms are stitched together, the optical component manifests a strong dispersion. An example of the optical component may be, e.g., a micro-mirror array.

The inset of FIG. 1B is a magnified view of a light beam of a given green wavelength λ_{g} being diffracted to an angle θ. The diffraction may be determined by:

Λ·sin(θ)=mλ_{g} (1),

where Λ is the periodicity of the group or array, and m is an integer. The optical path difference between the two green beams may be equal to an integer multiplied by Λ·sin(θ). According to Eq. (1), another light of a different wavelength, λ_{g}+βλ, is forbidden from propagating to the same angle θ, and propagates to a larger angle because of the increase in wavelength. This results in a strong negative dispersion, compared to refractory optics. The strong dispersion can also be understood from the fact that a constant wavenumber from periodicity

$$( \frac{1}{Λ} )$$

is applied to different wavelengths of incident light corresponding to different wavenumbers

$$( \frac{1}{λ} ) .$$

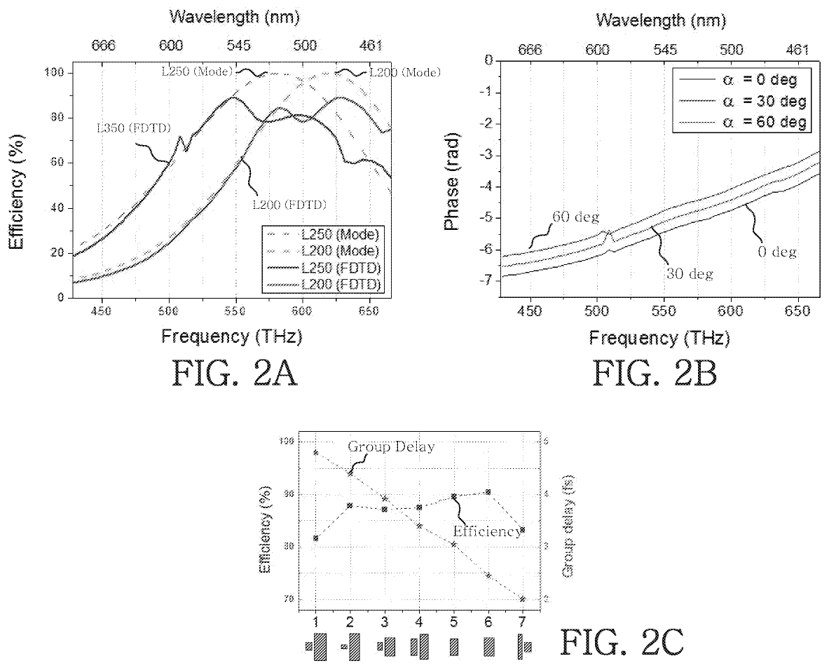

Thus, light beams of different wavelengths propagate to different angles. The dispersion shown in FIG. 2B is referred to as lattice dispersion, which may be avoided by the disclosed achromatic or dispersion tailored devices.

Achromatic Metasurfaces

FIG. 1C shows an achromatic metasurface beam deflector including an array of nanostructures on a substrate. For example, the deflector may include one or more groups (e.g, pairs) of one or more TiO₂ nano-fins of varying dimensions (in terms of length l and width w or in terms of cross-sectional area) but substantially equal height h. The nanostructures (e.g., nano-fins) may be evenly spaced by a distance p. In some embodiments, the h and p may have values of about 600 nm and about 400 nm. The definition of length l, width w, height h and rotation angle α are shown in FIG. 1C. In some embodiments, for the achromatic design to avoid lattice dispersion, no two groups of nano-fins are identical across the metasurface, with varying length l, width w, and rotation angle α across the groups of nano-fins. The substrate may be, e.g., a glass (e.g., silicon dioxide (SiO₂)) substrate. In some embodiments, in addition or alternative to TiO₂, the nanostructures may include other suitable dielectric materials including those having a light transmittance over a design wavelength or a range of design wavelengths of at least about 40%, at least about 50%, at least about 60%, at least about 70%, at least about 80%, at least about 85%, at least about 90%, or at least about 95%. For example, other suitable dielectric materials can be selected from oxides (such as an oxide of aluminum (e.g., Al₂O₃), silicon (e.g., SiO₂), hafnium (e.g., HfO₂), zinc (e.g., ZnO), magnesium (e.g., MgO), or titanium (e.g., TiO₂)), nitrides (such as nitrides of silicon (e.g., Si₃N₄), boron (e.g., BN), or tungsten (e.g., WN)), sulfides and pure elements. In some embodiments, a cross-section of each nanostructures has a two-fold symmetry, such as rectangular or elliptical.

To deflect a chromatic beam at normal incidence to a fixed angle θ, the phase provided by the nanostructures may follow:

$$ϕ ( x , ω ) = - \frac{ω}{c} x sin ( θ ) , \qquad ( 2 )$$

where x, ω, and c are the spatial coordinate, the angular frequency and the speed of light, respectively. Eq. (2) shows that the phases provided by the nanostructure at a given position x are proportional to angular frequency, for an achromatic device. Eq. (2) may be expanded at an angular frequency ω₀ as:

$$ϕ ( x , ω ) = - \frac{{ω}_{0}}{c} x sin ( θ ) + \frac{d ϕ ( x , ω )}{d ω} ( ω - {ω}_{0} ) . \qquad ( 3 )$$

In some embodiments, conventional diffractive optics or metasurfaces may meet the requirement of the first term of Eq. (3). The conventional diffractive optics or metasurfaces do not satisfy the second term, which is associated with group delay, and result in the chromatic effect. The derivative of Eq. 2 with respect to angular frequency leads to a group delay at a given coordinate x as:

$$\frac{d ϕ ( x , ω )}{d ω} = - \frac{x sin ( θ )}{c} . \qquad ( 4 )$$

Group delay:

In other words, the group delay can be defined as a partial derivative of phase φ(x, w) with respect to angular frequency, since x is independent of angular frequency ω. In some embodiments, a constant may be added in Eq. (4) for all angular frequencies, because the addition of the constant does not change the derivative

$$\frac{\partial ϕ}{\partial x}$$

that determines the deflection angle according to the generalized Snell's law. The freedom of adding a constant allows choosing structures that fulfill the condition of relative group delay. In some embodiments, the range of group delay provided by all possible geometric parameters (within fabrication limits) of the nanostructures can be the limiting factor for the overall size of a device.

In some embodiments, due to the absolute value of Eq. (4) being a monotonous increasing function of x, no two constituent units of nanostructures may be the same across the achromatic metasurface. Thus, both the phase and group delay may be satisfied simultaneously. In some embodiments, the disclosed optical component may control the phase and the group delay independently. In other words, for an arbitrary phase, the disclosed optical component may still achieve a group delay satisfying Eq. (4).

Independent Control of Phase and Group Delay

In some embodiments, a metasurface may include nanostructures (e.g., rectangular TiO₂ nano-fins) to control the phase and the group delay independently. The nanostructures may be high aspect ratio nanostructures realized by, e.g., electron beam lithography followed by atomic layer deposition. For example, when a left-handed circularly polarized beam ([1 i]′) passes through a nano-fin, the transmitted light may be described by a Jones vector:

$$\frac{{\tilde{t}}_{L} + {\tilde{t}}_{S}}{2} [ \begin{matrix}1 \\ i\end{matrix} ] + \frac{{\tilde{t}}_{L} + {\tilde{t}}_{S}}{2} \cdot exp ( i 2α ) [ \begin{matrix}1 \\ - i\end{matrix} ] , \qquad ( 5 )$$

where the symbol “˜” denotes for complex number, \tilde{t}_{L} and \tilde{t}_{S} respectively represent transmitted light when the incident light is polarized along the long and short axis of the nano-fin, and α is the rotation angle of the nano-fin with respect to x-axis. The second term in Eq. (5) shows that a portion of incident light may be converted to an orthogonal polarization state ([1−i]′). The squared normalized amplitude of the term may be referred to as the polarization conversion efficiency. The phase provided by the nanostructure may be determined by the product (\tilde{t}_{L}−\tilde{t}_{S})·exp(i2α), whereas the group delay

$$\frac{d ϕ}{d ω}$$

is related to \tilde{t}_{L}−\tilde{t}_{S}, since α is frequency-independent. This additional degree of freedom allows decoupling the phase and the group delay. For example, the dimensions of the nanostructures can be designed to satisfy the group delay and then the rotation angles α of the nanostructures are adjusted to meet the phase profile for every location on the achromatic device.

In some embodiments, the transmitted electromagnetic wave \tilde{t}_{L} and \tilde{t}_{S} depends on the nanostructure (e.g., TiO₂ nano-fin). In some embodiments, each TiO₂ pillar of the nanostructure may be a truncated waveguide performing as a pure phase shifter (\tilde{t}=e^{jφ}). The phase of the transmitted electromagnetic wave of a nano-fin at a given coordinate x may be determined by:

$$ϕ ( x , v ) = \frac{ω}{c} {n}_{eff} h , \qquad ( 6 )$$

where n_{eff} and h represent the effective index and the height of the nano-fin, respectively.

FIGS. 2A-2C illustrate simulations of optical properties of nanostructures. FIG. 2A illustrates simulations of polarization conversion efficiencies for different nano-fins' lengths from finite-difference time-domain (FDTD) method (solid lines) and Mode solution (dashed lines). In some embodiments, the lengths of the nano-fins are shown in the legend. The nano-fins have a constant width w=80 nm. FIG. 2B illustrates simulations of phases as functions of rotation angles for a nano-fin. In some embodiments, the nano-fin has a length l=about 250 nm and a width w=about 80 nm. FIG. 2C illustrates simulations of polarization conversion efficiencies and group delays at a wavelength (of, e.g., about 500 nm) for different parameters of the nano-fins. The group delays may be obtained using, e.g., linear fit to each phase plot of the nano-fins within a bandwidth of about 100 nm centered at about 500 nm. As shown in FIG. 2A-2C, the sizes (in nm) of nano-fins from units numbered one to seven are about (w₁=70, l₁=90, w₂=130, l₂=310), (w₁=70, l₁=50, w₂=110, l₂=310), (w₁=50, l₁=90, w₂=110, l₂=210), (w₁=50, l₁=190, w₂=90, l₂=290), (w=90, l=190), (w=210, l=110) and (w₁=50, l₁=290, w₂=70, l₂=110), respectively. The gap between two nano-fins may be about 60 nm.

FIG. 2A shows a comparison of polarization conversion efficiency using effective index method versus finite-difference time-domain (FDTD) method. The two methods are in good qualitative agreement. The large deviation at high frequencies results from the excitation of higher order modes and the resonances of the nano-fin. The derivative of Eq. (6) with respect to angular frequency is:

$$\frac{d ϕ ( x , ω )}{d ω} = \frac{h}{c} {n}_{eff} + \frac{h \cdot ω}{c} \frac{{dn}_{eff}}{d ω} \qquad ( 7 )$$

The derivative yields the group delay, which can be controlled by the height h and the n_{eff} of the nano-fin. The effective index n_{eff} can be adjusted by, e.g., the geometric parameters (e.g., the length l and width w of the TiO₂ nano-fin).

FIG. 2B shows a plot of phase as a function of frequency for a nano-fin with l=250 nm and w=80 nm with different rotations. The slope is quasi-linear within a bandwidth, and is independent to the rotation angle of each nano-fin. This freedom allows designing achromatic metasurface devices with a large bandwidth. FIG. 2C shows the group delays and polarization conversion efficiencies of different nano-fins at a wavelength λ=about 500 nm.

Achromatic and Dispersive Optical Components

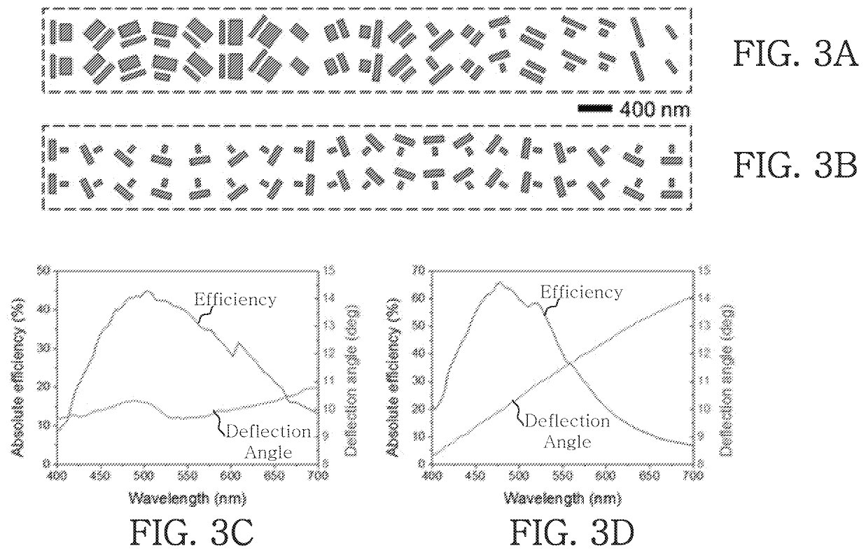

FIGS. 3A and 3B schematically illustrate two beam deflectors with and without controlling group delay, respectively. In some embodiments, the beam deflector is designed at about 500 nm with a deflection angle of about 10°. In FIG. 3B, the unit cells have the same, constant group delay. In contrast, the unit cells of FIG. 3A have group delays that vary substantially linearly with the spatial coordinate.

FIG. 3C illustrates absolute beam deflection efficiencies and deflection angles as functions of wavelengths for the beam deflector of FIG. 3A. FIG. 3D illustrates absolute beam deflection efficiencies and deflection angles as functions of wavelengths for the beam deflector of FIG. 3B. The absolute efficiencies may be calculated by the power of the beam at desired angle divided by that of incident light in the case of left-hand circular polarization. The deflection angles in FIG. 3C may be maintained around the design angle 10° from 400 nm to 600 nm with a high deflection efficiency. In embodiments as illustrated in FIG. 3B, the deflection angle changes significantly following the grating formula:

$$θ = {sin}^{- 1} ( \frac{λ}{{λ}_{d}} \cdot sin ( {10}^{°} ) ) ,$$

where design wavelength λ_{d}=500 nm.

In some embodiments, the approach may be used to realize other types of achromatic or dispersion-tailored meta-lenses. For example, to design an infinite-conjugate meta-lens that can focus light in normal incidence, the nano-fins may implement the phase profile:

$$φ ( r , ω ) = - \frac{ω}{c} ( \sqrt{{r}^{2} + {F}^{2}} - F ) , \qquad ( 8 )$$

where r and F are radial coordinate and focal length, respectively. The focal length can be generalized as:

F=k×ωⁿ (9),

where k may be a positive constant and n may be a real number which controls the chromatic dispersion of a meta-lens. In some embodiments, the meta-lens has a tailored equivalent Abbe number (V_{d}), and may not be a constant value (of, e.g., about −3.45) in diffractive optics (e.g., order n=1). From Eq. (9), the positive and negative values of n imply that shorter wavelengths are focused farther from the meta-lens, and that longer wavelengths are focused closer to the meta-lens. The larger the absolute value of n, the larger is the separation between the focal spots of two wavelengths resulting in stronger dispersion.

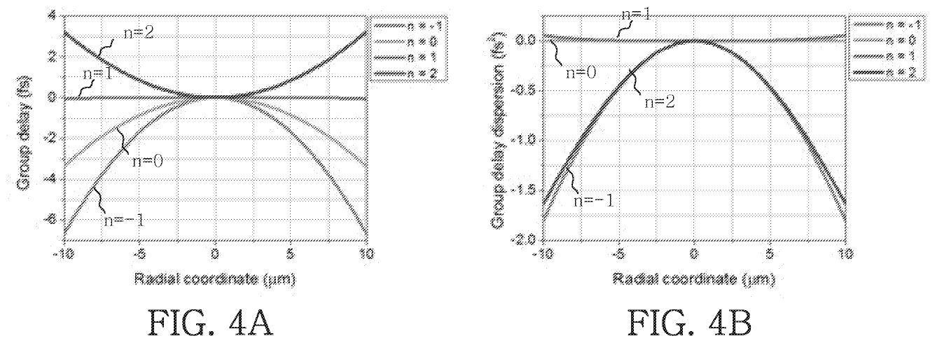

FIGS. 4A and 4B illustrate the group delays and the group delay dispersions as a function of the radial lens coordinate for tailoring meta-lens dispersions. The group delay

$$( \frac{\partial ϕ}{\partial ω} )$$

and group delay dispersion

$$( \frac{{\partial }^{2} ϕ}{\partial {ω}^{2}} )$$

are defined as the first- and second-order derivatives of phase (Eq. (8)) with respect to the angular frequency ω. The cases of n=0 and n=1 correspond to achromatic and diffractive lenses, respectively. In some embodiments, the lens has a numerical aperture (NA)=about 0.2 at wavelength λ=about 530 nm. The NA may be a function of wavelength for n≠0 implying the change of focal length. In such a case, the high order terms (group delay dispersion for example) may be satisfied in order to achieve broadband diffraction-limited focusing, with the full-width at half-maximum

$$FWHM = \frac{λ}{2 NA} .$$

For n=0, the meta-lens can focus a pulse beam without changing its pulse width and shape because the group delay dispersion term as well as any other higher-order terms are zero.

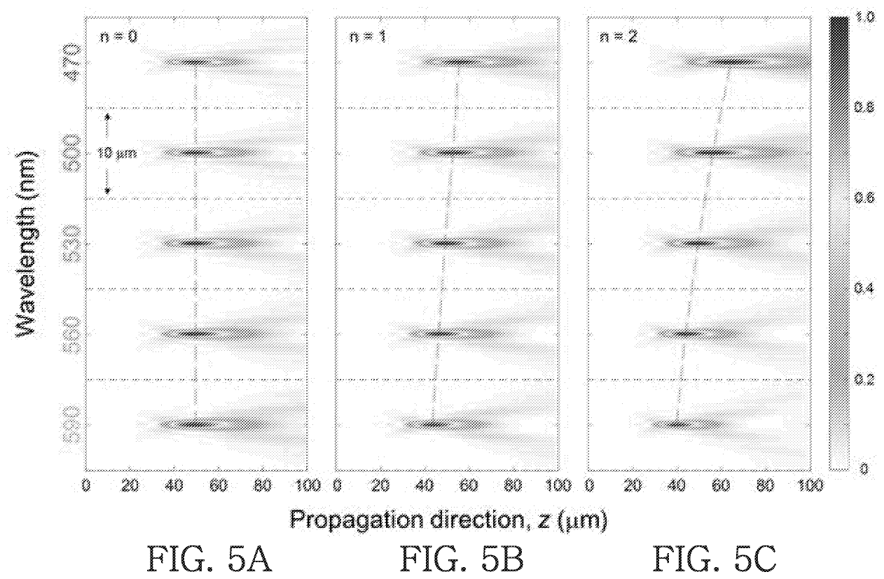

In some embodiments, the case of n=0 may correspond to achromatic lenses. FIG. 5A-5C illustrate simulated point spread functions of meta-lenses with n=0, 1 and 2, respectively. These meta-lenses, having an NA=0.2 and F=49 μm at λ=530 nm, include assemblies of nano-fins. The meta-lenses are located at z=0, and the incident beam is propagating toward positive z-direction with wavelengths noted at the y-axis. The n values at the top-left corners of FIGS. 5A-5C represent achromatic, dispersive and super-dispersive meta-lenses, showing the versatility of the dispersion engineering approach. The point spread functions may be calculated by propagating the amplitude and phase of each nano-fin on the meta-lenses, which may be obtained by FDTD simulation through scalar diffraction theory. The dashed lines passing through the maximum intensities of each focal spots of different wavelengths are plotted for the ease of visualization of the focal spot movements.

The nano-fins are chosen in such a way that the nano-fins satisfy (amongst the available parameters which are possible to be fabricated) the group delay profile at λ=530 nm for every spatial location on the meta-lenses. In FIG. 5A, focal length may be maintained a substantially constant (˜49 μm) showing achromatic focusing, while in FIGS. 5B and 5C, the focal spot positions change with the wavelengths. FIG. 5C also shows that the focal spot size may not be diffraction-limited when incident wavelength λ is away from 530 nm, because the neglect of group delay dispersion

$$\frac{{d}^{2} ϕ}{d {ω}^{2}} .$$

The meta-lenses (n=1, 2) with rapidly changing focal length may find applications in wavelength-tunable zoom lenses. Unlike conventional zoom lenses, the focal lengths can be tuned without mechanical movement.

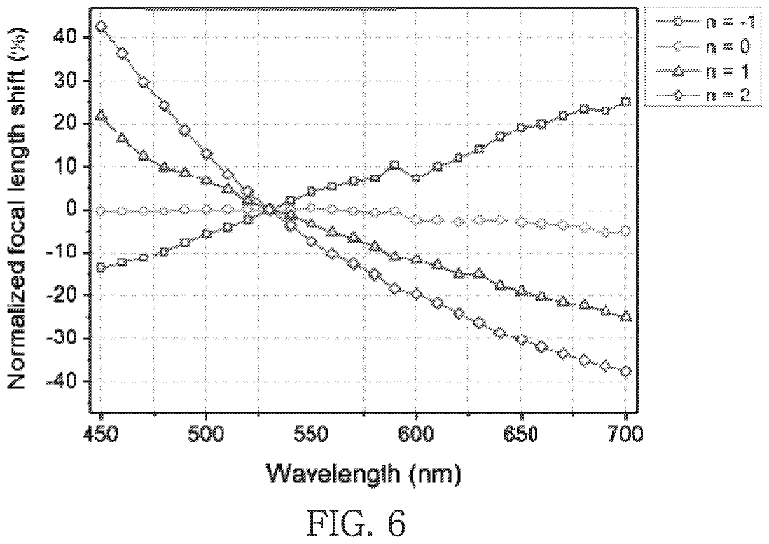

FIG. 6 illustrates the normalized focal length shifts as functions of wavelengths for different meta-lenses from 450 nm to 700 nm, corresponding to the meta-lenses shown in FIGS. 5A-5C, together with a meta-lens that has reversed focal length shift (n=−1). The positive values of n correspond to focal length shift similar to diffractive optics, while the negative n corresponds to that in refractive lenses. For n=−1, 0, 1 and 2, the meta-lenses may be designed at λ=530 nm with 120 nm bandwidth by satisfying the phase and group delay given by Eq. (8) and Eq. (9). For n=−1, the meta-lens has a NA=0.1 and a focal length of 99 μm at 530 nm, while the rest have a NA=0.2 and a focal length of 49 μm.

By the lensmaker's equation, their equivalent Abbe numbers (V_{d}) may be defined as:

$${V}_{d} = \frac{1 / {F}_{589.3}}{1 / {F}_{486.1} - 1 / {F}_{656.3}} , \qquad ( 10 )$$

where F_{589.3} represents the focal length of a meta-lens at wavelength λ=589.3 nm. The equivalent Abbe numbers for n=−1, 0, 1 and 2 maybe 3.53, −33.42, −3.38 and −1.93, respectively. The smaller absolute value of V_{d} represents stronger dispersion, while the negative sign of V_{d} reflects the opposite focusing tendency when compared with that for glass lenses. In conventional diffractive optics the Abbe number is a constant of −3.45, which is too large to be totally compensated by cascading a refractive lens (their Abbe numbers are usually between 30 to 70) resulting in secondary spectrum, i.e. residual chromatic aberration. In contrast, the tunable Abbe number allows correcting chromatic aberration beyond the limitation of using conventional lens materials.

By fitting the group delay and phase (as in Eq. (7)), the chromatic effect can be corrected or minimized. To realize a device that is achromatic over a bandwidth, the group delay of a nano-structure at a given location may be designed to be independent to angular frequency. In other words, the summation of n_{eff} and

$$ω \cdot \frac{d {n}_{eff}}{d ω} ,$$

which is equal to group index (n_{g}), may be a constant. The group velocity dispersion (GVD), which is proportional to the derivative of n_{g} with respect to angular frequency and equal to the group delay dispersion divided by propagation length, is therefore zero. In some embodiments, zero GVD may be achieved by controlling waveguide dispersion to compensate material dispersion. This may be achieved through placing two or more waveguides closely to support a slot mode, in which light is confined in between the waveguides.

To achieve a large size or a high NA of an achromatic meta-lens, the range of group delay may be increased by, e.g., either using different heights or through resonances of the nano-fins. The resonance may limit the bandwidth of an achromatic meta-lens, which is given by the quality factor of the resonances and is usually narrow in pure dielectric system. Different heights of nano-fins may be realized by either multi-lithography processes or using two photo-polymerization. Alternately, the disclose technology can lower the chromatic effect of meta-lenses with n in between 0 and 1, with smaller group delay, then cascading a conventional refractory lens to compensate the longitudinal chromatic effect. Through this approach, other monochromatic aberrations especially coma may also be corrected by changing the phase profile and curvature of the meta-lens and refractory lens, respectively.

It is to be understood that the term “design” or “designed” (e.g., as used in “design wavelength,” “design focal length” or other similar phrases disclosed herein) refers to parameters set during a design phase; which parameters after fabrication may have an associated tolerance.

As used herein, the singular terms “a,” “an,” and “the” may include plural referents unless the context clearly dictates otherwise.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An optical device, comprising:
a metasurface including a plurality of nanostructures, the nanostructures define a phase profile and a group delay profile at a design wavelength;
wherein the group delay profile controls a chromatic dispersion of the metasurface and the phase profile determines a functionality of the metasurface.

2. The optical device of claim 1, wherein the optical device is an achromatic deflector that receives light beams of different wavelengths at a normal incidence and deflect the light beams of different wavelengths to a common angle.

3. The optical device of claim 2, wherein the achromatic deflector is an achromatic waveguide coupler.

4. The optical device of claim 1, wherein the optical device is an achromatic lens that is configured to focus light of a range of different wavelengths to a common spot.

5. The optical device of claim 4, wherein the achromatic lens is at least one of an infinite-conjugate achromatic lens, conjugate achromatic lens or a total internal reflection achromatic lens.

6. The optical device of claim 1, wherein the optical device is a lens with tunable dispersion that is configured to focus light of a range of different wavelengths to one or more spots.

7. The optical device of claim 1, wherein the plurality of nanostructures comprise at least one of an oxide, a nitride, a sulfide, a pure element, or a combination of two or more thereof.

8. The optical device of claim 1, wherein a cross-section of each of the plurality of nanostructures has a two-fold symmetry.

9. The optical device of claim 8, wherein the cross-section is rectangular.

10. The optical device of claim 8, wherein the cross-section is elliptical.

11. The optical device of claim 1, wherein the group delay profile is a derivative of the phase profile with respect to an angular frequency of an incident light.

12. The optical device of claim 1, wherein the group delay profile depends on a difference of transmitted electric fields of light polarized along two symmetrical axes of the nanostructures.

13. The optical device of claim 1, wherein the phase profile depends on a difference of transmitted electric fields of light polarized along two symmetrical axes of the nanostructures, and further depends on rotation angles of the nanostructures with respect to an axis of the metasurface.

14. The optical device of claim 1, wherein the design wavelength is within a range from ultraviolet to infrared.

15. The optical device of claim 1, wherein the phase profile at a given location x is:
$$ϕ ( x , ω ) = \frac{ω}{c} {n}_{eff} h ,$$
where x is a spatial coordinate of the nanostructures, ω is an angular frequency of an incident light, c is the speed of light, n_{eff} is an effective index of the nanostructures, and h is a height of the nanostructures.

16. The optical device of claim 1, wherein the group delay profile at a given location x is:
$$\frac{d ϕ ( x , ω )}{d ω} = \frac{h}{c} {n}_{eff} + \frac{h \cdot ω}{c} \frac{{dn}_{eff}}{d ω} ,$$
where x is a spatial coordinate of the nanostructures, ω is an angular frequency of an incident light, c is the speed of light, n_{eff} is an effective index of the nanostructures, and h is a height of the nanostructures.

17. The optical device of claim 1, wherein the nanostructures further define a group delay dispersion profile, the group delay dispersion profile is a second-order derivative of the phase profile with respect to an angular frequency of an incident light.

18. An optical device, comprising:
a metasurface including a plurality of nanostructures, the nanostructures define a phase profile, a group delay profile and a group delay dispersion profile that control the chromatic dispersion of the metasurface;
wherein each nanostructure of the nanostructures has geometries that satisfy both the group delay profile and the group delay dispersion profile, and each nanostructure has a rotation angle that satisfies the phase profile.

19. The optical device of claim 18, wherein the group delay profile is a derivative of the phase profile with respect to a frequency of an incident light.

20. The optical device of claim 18, wherein the group delay dispersion profile is a second-order derivative of the phase profile with respect to a frequency of an incident light.

21. The optical device of claim 18, wherein the group delay profile is controlled by a height and an effective index of the plurality of nanostructures.

22. The optical device of claim 18, wherein the optical device is an achromatic deflector that receives light beams of different wavelengths at a normal incidence and deflect the light beams of different wavelengths to a common angle.

23. The optical device of claim 18, wherein the optical device is an achromatic lens that is configured to focus light of a range of different wavelengths to a common focal spot.

24. The optical device of claim 18, wherein the nanostructures include a plurality of groups of nano-fins, each group of nano-fin including a first nano-fin and a second nano-fin having substantially the same height, and having different lengths and widths.
